(19) United States
(12) Patent Application Publication
(10) Pub. No.: US 2026/0350992 A1
(43) Pub. Date: Nov. 5, 2026

(54) METHOD AND SYSTEM FOR DETECTING TRANSITION IN A VIDEO

(71) Applicant: CARDINAL BLUE SOFTWARE, INC., MOUNTAIN VIEW, CA (US)

(72) Inventor: Vinay Kumar Sisodia, Taipei City (TW)

(21) Appl. No.: 19/195,926

(22) Filed: May 1, 2025

(51) Int. Cl. G06V 20/40; G06V 10/70

(52) U.S. Cl. CPC G06V 20/46; G06V 10/70; G06V 20/49

(57) ABSTRACT

A transition detecting method and a transition detecting system for identifying a transition in a video are disclosed. The method includes following steps: obtaining n frames from the video, wherein n is a natural number; obtaining a frame embedding of each of the n frames through an image embedding module; calculating an adjacency matrix and a degree matrix based on the n frame embeddings; calculating a Laplacian matrix based on the adjacency matrix and the degree matrix; obtaining Fiedler vector values from the Laplacian matrix, wherein each of the Fiedler vector values represents each of the n frames; and, detecting whether any sign change occurs between any two adjacent Fiedler vector values; if so, identifying that a transition exists between the two adjacent frames.

### BACKGROUND

### 1. Technical Field

The present disclosure relates to a transition detecting method and a transition detecting system for detecting a transition in a video, and more particularly, to a transition detecting method and a transition detecting system in which transitions are detected using Fiedler vectors.

### 2. Description of the Related Art

One aspect of video understanding is detecting transitions in a video. Video understanding refers to the ability to understand what is happening in a video at a semantic level. A transition in a video can be defined as a large and fast change in the (semantic) content of a video. Detecting transitions in a video provides a systematic way to divide a video into smaller clips. These clips can then be used for downstream processing of a video.

A common approach for detecting transitions in a video generally follows these steps: extract frames for selecting a set of frames from the video; obtain image embeddings for extracting high-level semantic information from each frame by generating image embeddings using a pre-trained image embedding model; measure similarity for computing the similarity between adjacent frames using a distance metric, such as L2 distance or cosine distance; and detect transitions by applying a heuristic threshold to determine whether two adjacent frames are sufficiently different. If they exceed the threshold, a transition is identified. Since the above-mentioned steps require defining a threshold, there is a possibility of inaccurate or imprecise detection. This threshold also depends on the embedding model used to calculate the frame embeddings. If a different embedding model is used, the threshold needs to be modified. Therefore, there is a need to improve the algorithm for detecting transitions in a video.

### SUMMARY

It is an object of the present invention to provide a transition detecting method in which transitions are detected using Fiedler vectors.

It is another object of the present invention to provide a transition detecting system in which transitions are detected using Fiedler vectors.

To achieve the above objectives, the present disclosure provides a transition detecting method for detecting at least one transition in a video, including following steps: obtaining n frames from the video, wherein n is a natural number; obtaining a frame embedding of each of the n frames through an image embedding module, wherein the image embedding module can be a machine learning model, an image embedding model, or a similar approach; calculating an adjacency matrix and a degree matrix based on the n frame embeddings; calculating a Laplacian matrix based on the adjacency matrix and the degree matrix; obtaining Fiedler vector values from the Laplacian matrix, wherein each of the Fiedler vector values represents each of the n frames; and detecting whether any sign change occurs between any two adjacent Fiedler vector values; if so, identifying that a transition exists between the two adjacent frames.

To achieve the above objectives, the present disclosure further provides a transition detecting system for detecting at least one transition in a video, including a frame obtaining module, an image embedding module, a processor, and a transition detecting module. The frame obtaining module is applied for obtaining n frames from the video, wherein n is a natural number. The image embedding module is applied for obtaining a frame embedding of each of the n frames. The processor is applied for calculating an adjacency matrix and a degree matrix based on the n frame embeddings, calculating a Laplacian matrix based on the adjacency matrix and the degree matrix, and obtaining Fiedler vector values from the Laplacian matrix, wherein each of the Fiedler vector values represents each of the n frames. The transition detecting module is applied for detecting whether any sign change occurs between any two adjacent Fiedler vector values; if so, identifying that a transition exists between the corresponding two adjacent frames.

The present disclosure relates to a novel approach for detecting transitions in a video by constructing a fully connected graph from the video and leveraging the spectral properties of its Laplacian matrix (L) to identify transition points. Broadly speaking, a transition between any two adjacent frames, such as frames i and j, corresponds to vertices i and j being weakly connected. The strength or weakness of these connections is captured by the eigenvectors and eigenvalues of the Laplacian matrix L.

The transition detecting method and the transition detecting system of the present disclosure offers several advantages that cannot be found in existing approaches. One key advantage is its model-agnostic nature. The image embedding module can be any pre-trained image encoder that to be used to compute the frame embedding, which are then utilized to derive the graph Laplacian and, subsequently, the transitions. As long as the image embedding module (encoder) can effectively capture semantic information, it can be integrated into the process without requiring modifications to the algorithm.

Another advantage of the transition detecting method and the transition detecting system of the present disclosure is its ability to quantify the strength of transitions with theoretical bounds, given an appropriate choice of metric. Specifically, when cosine similarity is used as the metric to construct the adjacency matrix A of size (n, n), the corresponding Laplacian matrix L will have its largest eigenvalue bounded by n, the size of the matrix. In other words, if the eigenvalues of L are denoted as λ₁≥λ₂≥ . . . ≥λₙ, then λₙ=0 and λ₁≤n. This establishes the upper and lower bounds as:

$$1 \geq \frac{{λ}_{1}}{n} \geq \frac{{λ}_{2}}{n} \geq … \geq \frac{{λ}_{n}}{n} = 0 .$$

According to one embodiment of the present disclosure, these bounds enable the quantification of the relative uniformity of frames within a video and even allow for comparisons between different videos.

### BRIEF DESCRIPTION OF THE DRAWINGS

FIG. 1 is the flowchart showing a transition detecting method according to one embodiment of the present disclosure.

FIG. 2 is one schematic diagram illustrating the obtained frames from a video; and

FIG. 3 is another schematic diagram illustrating a hardware structure of a transition detecting system according to one embodiment of the present disclosure.

FIG. 4 is a schematic diagram illustrating a hardware structure of a transition detecting system according to one embodiment of the present disclosure.

### DETAILED DESCRIPTION OF THE EMBODIMENTS

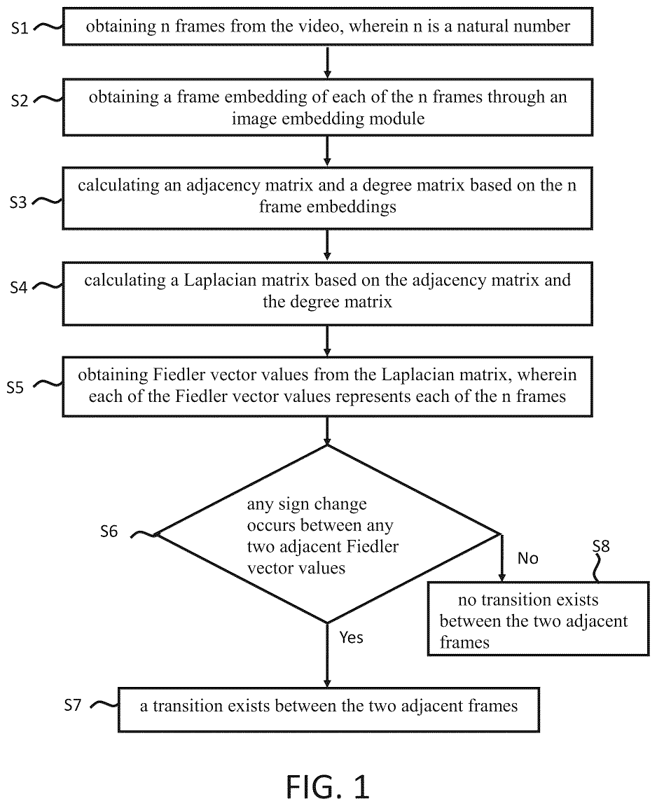

In order to make the structure and characteristics as well as the effectiveness of the present disclosure further understood and recognized, a detailed description of the present disclosure is provided as follows, along with embodiments and accompanying figures. Please refer to FIG. 1 to FIG. 4, which present the flowchart of a transition detecting method according to one embodiment of the present disclosure, two schematic diagrams illustrating the obtained frames from a video, and a schematic diagram illustrating a hardware structure of a transition detecting system.

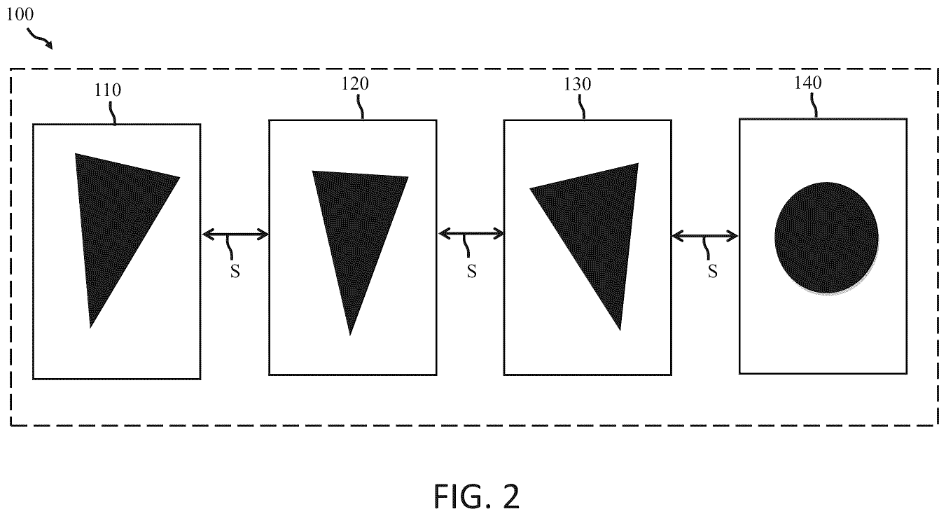

As shown in FIG. 1 and FIG. 2, in this embodiment, the transition detecting method for detecting a transition in a video of the present disclosure including the following steps:

S1: obtaining n frames from the video, wherein n is a natural number.

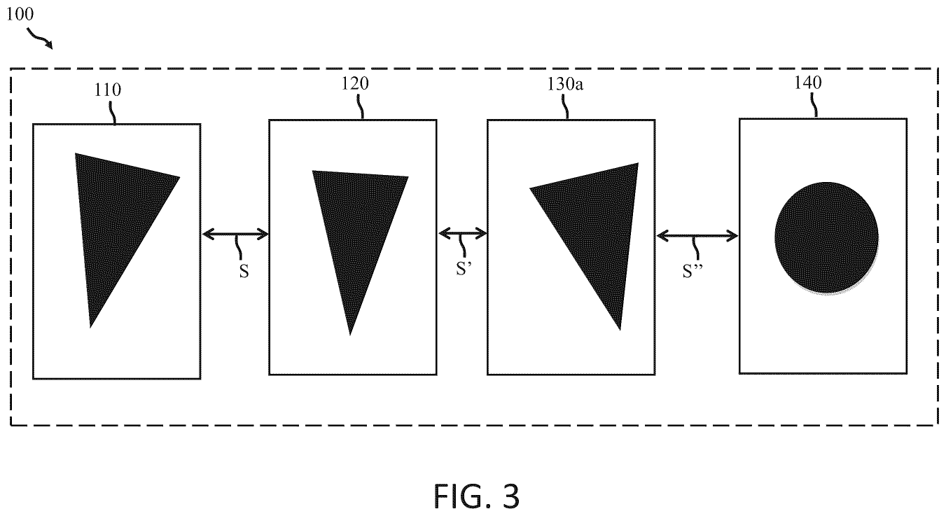

As shown in FIG. 2, frame 110, 120, 130, and 140 are extracted from video 100; i.e., n=4. It is noted that, in this embodiment, the time interval s between any two adjacent frames, for example, between frame 110 and frame 120, or between frame 130 and frame 140, is uniformly set to 1 second. However, the present disclosure is not limited with this embodiment; the time interval s can be variable. Please note that a uniform time interval represents the preferred embodiment of the present disclosure, but a variable time interval also produces adequate results. Both approaches are acceptable within the present disclosure. In other words, as shown in FIG. 3, the time interval s between frame 110 and 120, the time interval s′ between frame 120 and 130a, and the time interval s″ between frame 130a and 140 are all different. It is noted that, method for extracting frames from a video is well-known and is not the improved part of this disclosure; therefore, it is omitted.

S2: obtaining a frame embedding of each of the n frames through an image embedding module.

In this embodiment, the Clip ViT-B/32 model is used to extract semantic information from each of frame 110, 120, 130, and 140. The extracted semantic information of each frame is represented as frame embedding of each of frames 110, 120, 130, and 140. It is noted that, Clip ViT-B/32 model is provided for illustration purpose only. The image embedding module can be a machine learning model, an image embedding model, or a similar approach, and any pre-trained image encoder can be used to extract semantic information from each of the four frames. It is noted that, method for applying models to extract semantic information from frames is well-known and is not the improved part of this disclosure; therefore, it is omitted.

S3: calculating an adjacency matrix and a degree matrix based on the n frame embeddings.

Developing the adjacency matrix (A) and a degree matrix (D) based on the frame embeddings of each of frames 110, 120, 130, and 140. Each entry i,j of the adjacency matrix is the cosine similarity between the frame embeddings i and j. In this embodiment, the adjacency matrix (A) is represented as tensor of shape ([4, 4]) because n=4 in this embodiment, and degree matrix (D) is represented as:
tensor: [[3.8405, 0.0000, 0.0000, 0.0000],
   [0.0000, 3.8136, 0.0000, 0.0000],
   [0.0000, 0.0000, 3.8000, 0.0000],
[0.0000, 0.0000, 0.0000, 3.6452]].

The above tensor represents the graph of frames 110, 120, 130, and 140. Specifically: [3.8405, 0.0000, 0.0000, 0.0000] represents frame 110; [0.0000, 3.8136, 0.0000, 0.0000] represents frame 120; [0.0000, 0.0000, 3.8000, 0.0000] represents frame 130; [0.0000, 0.0000, 0.0000, 3.6452] represents frame 140.

S4: calculating a Laplacian matrix based on the adjacency matrix and the degree matrix.

Laplacian matrix (L) is defined as the difference between the degree matrix (D) and the adjacency matrix (A), i.e., L=D−A. The present disclosure has the ability to quantify the strength of transitions with theoretical bounds, given an appropriate choice of metric. Specifically, when cosine similarity is used as the metric to construct the adjacency matrix A of size (n, n), the corresponding Laplacian matrix L will have its largest eigenvalue bounded by n, the size of the matrix. In other words, if the eigenvalues of L are denoted as λ₁≥λ₂≥ . . . ≥λₙ, then λₙ=0 and λ₁≤n. This establishes the upper and lower bounds as:

$$1 \geq \frac{{λ}_{1}}{n} \geq \frac{{λ}_{2}}{n} \geq … \geq \frac{{λ}_{n}}{n} = 0 .$$

S5: obtaining Fiedler vector values from the Laplacian matrix, wherein each of the Fiedler vector values represents each of the n frames.

The eigenvalues and eigenvectors of the Laplacian matrix (L) are calculated, keeping the second smallest eigenvalue and its corresponding eigenvector. This eigenvector is denoted as the Fiedler vector. In this embodiment, the Fiedler vector is represented as tensor ([−0.2801, −0.2313, −0.3515, 0.8629]), where each value in the bracket corresponds to one of the four frames. Specifically, the first Fiedler vector value, −0.2801, represents frame 110; the second Fiedler vector value, −0.2313 represents frame 120; the third Fiedler vector value, −0.3515, represents frame 130; and the fourth Fiedler vector value, 0.8629, represents frame 140. The advantage of choosing the Fiedler vector values is that it has norm 1 and sums up to 0. This ensures that some values are positive while others are negative, facilitating the comparison of signs of consecutive frames.

S6: any sign change occurs between any two adjacent Fiedler vector values.

If sign change occurs between any two adjacent Fiedler vector values, whether from positive to negative, or vice versa, proceeding S7: a transition exists between the two adjacent frames. If no sign change occurs between any two adjacent Fiedler vector values, proceeding S8: no transition exists between the two adjacent frames. For instance, the Fiedler vector presented in S5 is represented as tensor ([−0.2801, −0.2313, −0.3515, 0.8629]). There is no sign change between frame 110 (−0.2801) and frame 120 (−0.2313) or between frame 120 (−0.2313) and frame 130 (−0.3515), meaning no transition occurs among frame 110, frame 120 and frame 130. In contrast, a sign change occurs in the last two Fiedler vector values, which correspond to frame 130 and frame 140 individually. Thus, it is identified that a transition happens between frame 130 and frame 140.

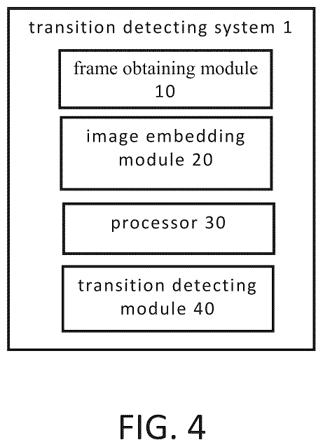

As shown in FIG. 4, in this embodiment, the transition detecting system 1 for detecting a transition in a video includes a frame obtaining module 10, an image embedding module 20, a processor 30, and a transition detecting module 40. The transition detecting system 1 can be a computer, laptop, smartphone, server, or other similar device. The processor 30 is signal-connected to the frame obtaining module 10, the image embedding module 20, and the transition detecting module 40. The frame obtaining module 10 is configured to extract n frames from the video, wherein n is a natural number. The image embedding module 20 is configured to generate a frame embedding for each of the n frames through an image embedding module.

The processor 30 is configured to compute an adjacency matrix (A) and a degree matrix (D) based on the n frame embeddings, derive a Laplacian matrix from the adjacency matrix and the degree matrix, and extract Fiedler vector values from the Laplacian matrix, wherein each of the Fiedler vector values corresponds to one of the n frames. The transition detecting module 40 is configured to determine whether a sign change occurs between any two adjacent Fiedler vector values. If a sign change is detected, it identifies a transition between the corresponding adjacent frames. It is noted that the details for detecting transitions in a video have already been presented in the steps of the transition detection method. Therefore, they are omitted.

The transition detecting method and the transition detecting system 1 of the present disclosure relates to a method and system for detecting transitions in a video using a graph-based approach. The video is represented as a fully connected graph, and transitions are identified based on the spectral properties of the graph's Laplacian matrix. Specifically, the second smallest eigenvalue and its corresponding eigenvector, known as the Fiedler vector, are used to detect significant semantic changes in the video content. This method is model-agnostic, compatible with various pre-trained image embedding models, and provides theoretical bounds on the uniformity of video content.

It should be noted that many of the above-mentioned embodiments are given as examples for description, and the scope of the present invention should be limited to the scope of the following claims and not limited by the above embodiments.

What is claimed is:

1. A transition detecting method for detecting at least one transition in a video, comprising:
obtaining n frames from the video, wherein n is a natural number;
obtaining a frame embedding of each of the n frames through an image embedding module;
calculating an adjacency matrix and a degree matrix based on the n frame embeddings;
calculating a Laplacian matrix based on the adjacency matrix and the degree matrix;
obtaining Fiedler vector values from the Laplacian matrix, wherein each of the Fiedler vector values represents each of the n frames; and
detecting whether any sign change occurs between any two adjacent Fiedler vector values; if so, identifying that a transition exists between the two adjacent frames.

2. The method as claimed in claim 1, wherein the time interval between any two adjacent frames is uniform.

3. The method as claimed in claim 1, wherein the time intervals between frames are either uniform or variable.

4. The method as claimed in claim 1, wherein the degree matrix corresponds to a fully connected undirected graph.

5. The method as claimed in claim 1, wherein the image embedding module is a pre-trained image encoder.

6. A transition detecting system for detecting at least one transition in a video, comprising:
a frame obtaining module for obtaining n frames from the video, wherein n is a natural number;
an image embedding module for obtaining a frame embedding of each of the n frames through an image embedding module;
a processor for calculating an adjacency matrix and a degree matrix based on the n frame embeddings, calculating a Laplacian matrix based on the adjacency matrix and the degree matrix, and obtaining Fiedler vector values from the Laplacian matrix, wherein each of the Fiedler vector values represents each of the n frames; and
a transition detecting module for detecting whether any sign change occurs between any two adjacent Fiedler vector values; if so, identifying that a transition exists between the two adjacent frames.

7. The system as claimed in claim 6, wherein the time interval between any two adjacent frames is uniform.

8. The system as claimed in claim 6, wherein the time intervals between frames are either uniform or variable.

9. The system as claimed in claim 6, wherein the degree matrix corresponds to a fully connected undirected graph.

10. The system as claimed in claim 6, wherein the image embedding module is a pre-trained image encoder.
